(19) United States
(12) Patent Application Publication
(10) Pub. No.: US 2002/0188880 A1
(43) Pub. Date: Dec. 12, 2002

(54) System and method for reducing power consumption by a liquid crystal display

(76) Inventors: Robert J. Lowles, Waterloo (CA); James A. Robinson, Elmira (CA)

Correspondence Address: Joseph M. Sauer, Esq., Jones, Day, Reavis & Pogue, North Point, 901 Lakeside Ave., Cleveland, OH, 44114, US

(21) Appl. No.: 10/131,959

(22) Filed: Apr. 25, 2002

Related U.S. Application Data
(60) Provisional application No. 60/286,857, filed on Apr. 26, 2001.

(51) Int. Cl. G06F 1/26; G06F 1/28; G06F 1/30

(52) U.S. Cl. 713/322

(57) ABSTRACT

A system for reducing power consumption by a liquid crystal display (LCD) is provided. One embodiment includes a processing device, an LCD controller and a switching device. The processing device is configured to generate a digital output having a first state and a second state. The LCD controller is coupled to the LCD and has a display clock input, wherein the frequency of the display clock input controls the frame frequency of the LCD. The switching device has a first input coupled to a first clock signal and a second input coupled to a second clock signal, and has a control input coupled to the digital output of the processing device. The first clock signal has a first frequency and the second clock signal has a second frequency. The switching device couples the first clock signal to the display clock input to the LCD controller when the digital output of the processing device is in the first state and couples the second clock signal to the display clock input to the LCD controller when the digital output of the processing device is in the second state.

### CROSS-REFERENCE TO RELATED APPLICATION

This application claims priority from and is related to the following prior application: Power Reduction Methods for a Liquid Crystal Display (LCD), United States Provisional Application No. 60/286,857, filed Apr. 26, 2001. This prior application, including the entire written description and drawing figures, is hereby incorporated into the present application by reference.

### FIELD OF THE INVENTION

This invention relates generally to liquid crystal displays (LCDs). More specifically, the invention provides a system and method for reducing power consumption by an LCD. This invention is particularly well-suited for use in Personal Digital Assistants, cellular telephones, and wireless two-way email communication devices (collectively referred to herein as “mobile communication devices”).

### BACKGROUND OF THE INVENTION

Power conservation is an important design criterion for many devices that utilize an LCD, such as mobile communication devices. It is often important, therefore, to minimize the power consumed by an LCD. This goal is often accomplished by reducing the frame frequency of the LCD, which is proportionate to the LCD's power consumption.

FIG. 1 is a graph 10 that illustrates the power consumption of a typical LCD as a function of its frame frequency. In order to minimize power consumption while avoiding the perception of a flickering image on the LCD, the frame frequency is commonly set around 75 Hz. A lower frame frequency will, however, still provide a virtually flicker-free display in most environments. For instance, a frame frequency of 68 Hz provides a display with very little flicker, and reduces the current consumption by approximately 70 μA, as shown in FIG. 1.

FIG. 2 is a table 20 that shows the battery life of a typical mobile communication device as a function of its LCD current. As illustrated in this table 20 and also in FIG. 1, if the average LCD current is reduced to 0.7 μA by lowering the frame frequency of the LCD, then the battery life may be extended by approximately 2 days.

FIG. 3 is a block diagram of a typical system 30 for reducing the frame frequency of an LCD 36 during periods of inactivity. The system 30 includes a processing device 32, an LCD controller 34, and the LCD 36. The processing device 32 generates a clock signal 38 that is coupled as an input to a display timing circuit generator 40 in the LCD controller 34. The display timing circuit generator 40 controls the frame frequency of the LCD 36 by generating a timing output 39 based on the clock signal input 38. The timing output 39 is coupled to an LCD driver 44 which generates an analog drive voltage 37 for the LCD 36 using the timing output 39 along with digital data 33 received from the processing device 32 and stored in a memory device 42. The processing device 32 may, therefore, reduce the frame frequency of the LCD 36 by reconfiguring the clock signal 38.

Operationally, the processing device 32 conserves power by reducing the frame frequency of the LCD 36 when the system 30 has been inactive for a pre-determined period of time. For instance, if the system 30 is in a mobile communication device, then the processing device 32 may monitor user interaction, and reduce the frame frequency if the user has not interacted with the device for a selected amount of time. Once user activity is detected by the processing device 32, the frame frequency of the LCD 36 is returned to a level suitable for comfortable viewing. Even during periods in which the frame frequency is reduced, however, this system 30 requires the processing device 32 to continue generating the clock signal 38, thus consuming power and reducing battery life.

### SUMMARY

A system for reducing power consumption by a liquid crystal display (LCD) is provided. One embodiment includes a processing device, an LCD controller and a switching device. The processing device is configured to generate a digital output having a first state and a second state. The LCD controller is coupled to the LCD and has a display clock input, wherein the frequency of the display clock input controls the frame frequency of the LCD. The switching device has a first input coupled to a first clock signal and a second input coupled to a second clock signal, and has a control input coupled to the digital output of the processing device. The first clock signal has a first frequency and the second clock signal has a second frequency. The switching device couples the first clock signal to the display clock input to the LCD controller when the digital output of the processing device is in the first state and couples the second clock signal to the display clock input to the LCD controller when the digital output of the processing device is in the second state.

Another embodiment includes a processing device and an LCD controller. The processing device is configured to detect a triggering event in the mobile communication device and to generate an event trigger signal. The LCD controller, which includes a switching device and a timer, is coupled to the processing device. The switching device has a control input, a first input coupled to a first clock signal of a first frequency, and a second input coupled to a second clock signal of a second frequency. The timer is coupled to the event trigger signal and the control input of the switching device. The timer generates a control signal on the control input to the switching device to select the first input to the switching device as a display clock output from the switching device when the event trigger signal indicates the occurrence of the triggering event. In addition, the control signal generated by the timer selects the second input to the switching device as the display clock output from the switching device if the triggering event has not been detected for a pre-determined time interval. The LCD controller controls the frame frequency of the LCD as a function of the display clock output from the switching device.

### BRIEF DESCRIPTION OF THE DRAWINGS

FIG. 1 is a graph that illustrates the power consumption of a typical LCD as a function of its frame frequency;

FIG. 2 is a table that shows the battery life of a typical mobile communication device as a function of its LCD current;

FIG. 3 is a block diagram of a typical system for reducing the frame frequency of an LCD during periods of inactivity;

FIG. 4 is a block diagram of an exemplary LCD power conservation system;

FIG. 5 is block diagram of another exemplary LCD power conservation system;

FIG. 6a shows a typical LCD display in a mobile communication device during normal operation;

FIG. 6b shows the typical LCD display of FIG. 6a in an exemplary reduced pixel mode of operation; and

FIG. 7 is a flow diagram illustrating an exemplary method for implementing dynamic frame frequency adjustment and a reduced pixel mode for an LCD.

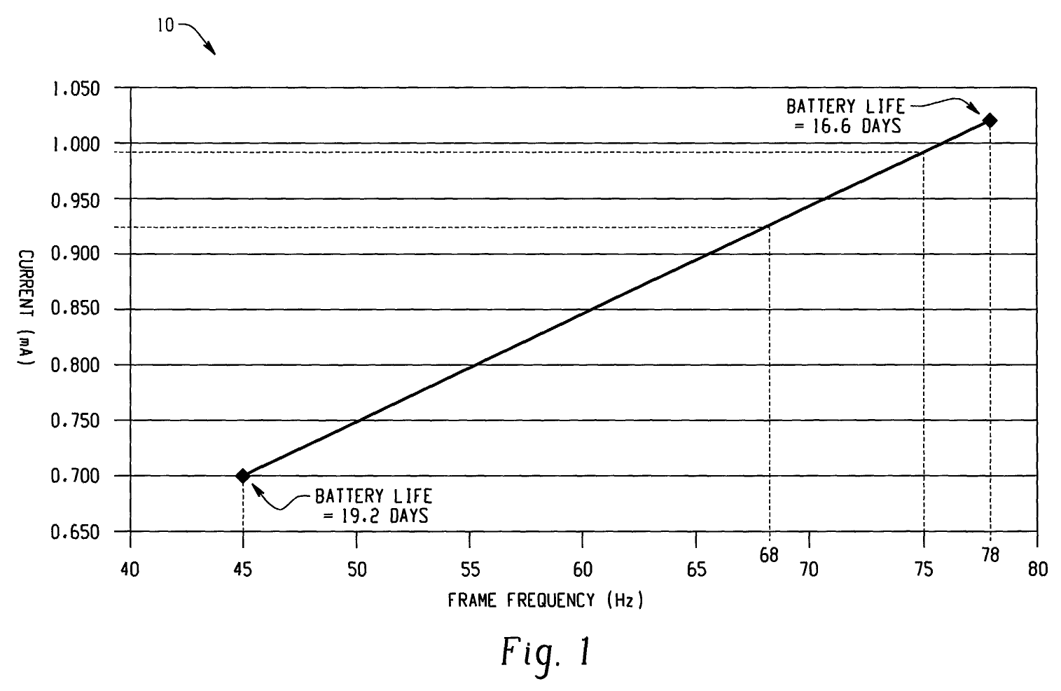

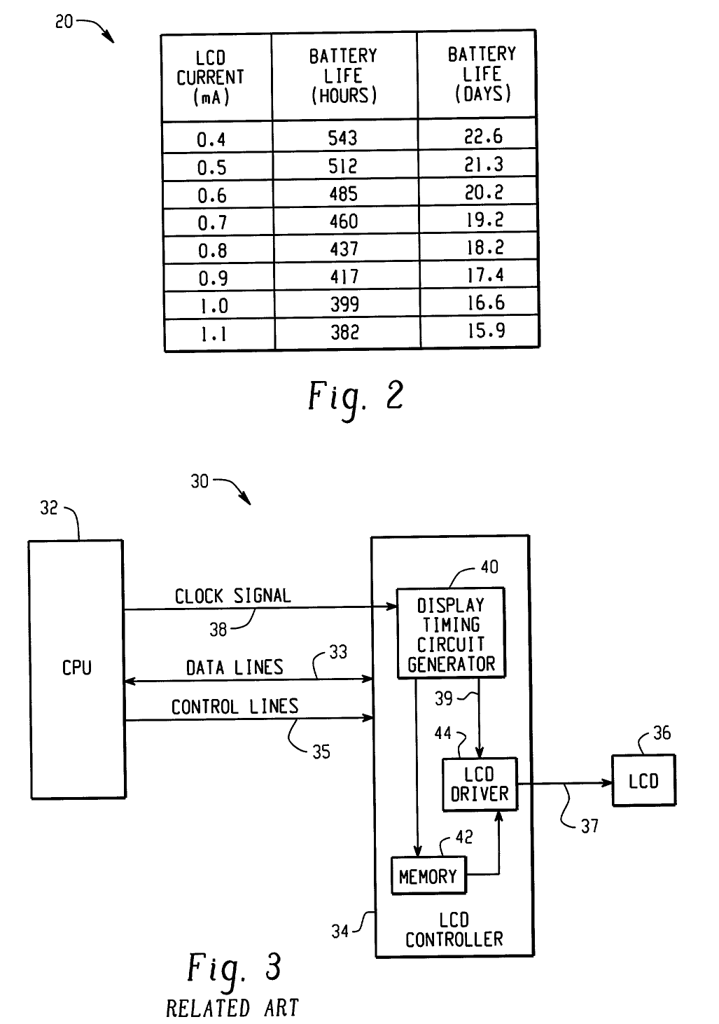

### DETAILED DESCRIPTION

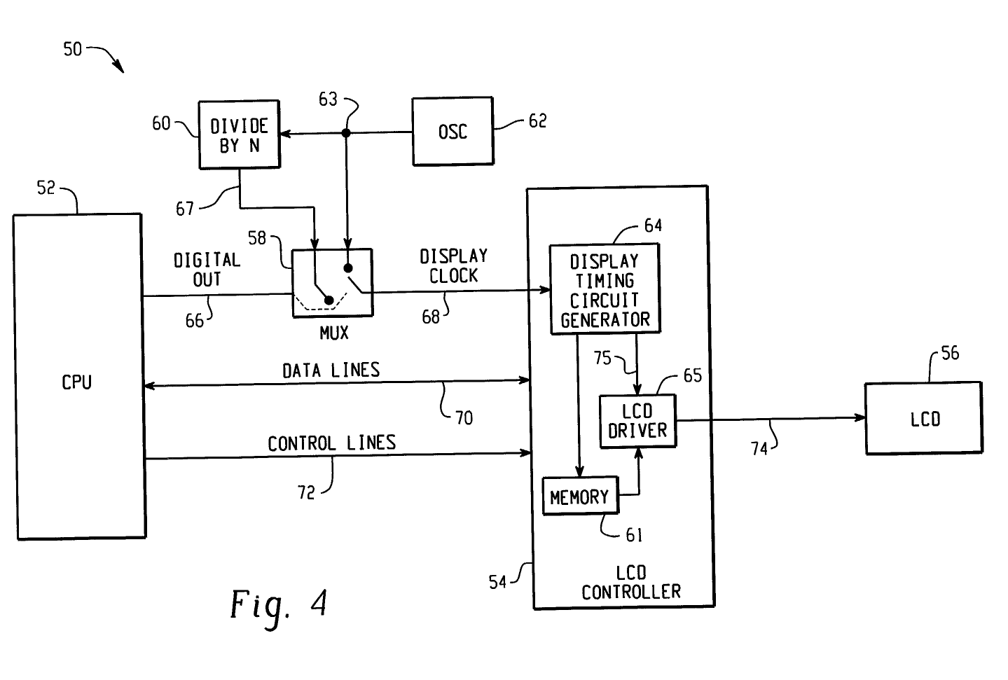

Referring now to the remaining drawing figures, FIG. 4 is a block diagram of an exemplary LCD power conservation system 50. The LCD power conservation system 50 includes a processing device 52, an LCD controller 54 and an LCD 56. In addition, the system 50 includes a switching device 58, a divider 60, and an external oscillator 62. Operationally, the processing device 52 controls the frame frequency of the LCD 56 by using the switching device 58 to select between a first clock signal 63 generated by the external oscillator 62 and a slower, second clock signal 67 generated by the divider 60.

The processing device 52 generates a digital output 66 that is coupled as a control input to the switching device 58. In addition, the processing device 52 is coupled to the LCD controller 54 by a data line 70 and a control line 72 that transmit display data and commands from the processing device 52 to the LCD controller 54. The processing device 52 may, for example, be a central processing unit (CPU), a digital signal processor (DSP), or some other type of processor or dedicated logic circuitry. The switching device 58 may, for example, be a multiplexer, or may be some other type of switching component or circuitry.

The external oscillator 62 generates the first clock signal 63 which is coupled as one input to the switching device 58 and is also coupled to the divider 60. The divider 60 divides the first clock signal 63 by a pre-determined value (N), and generates a slower, second clock signal 67, which is coupled as a second input to the switching device 58. The divider 60 may, for example, be a divide-by-N counter, or may be some other type of circuit or component capable of dividing the frequency of a signal by a pre-determined value (N). The switching device 58 also receives a control input 66 from the processing device 66, which controls which of the first or second clock signal inputs 63, 67 is coupled as a display clock signal 68 input to the LCD controller 54. If a slower frame frequency (“alternate frame frequency”) for the LCD 56 is desired, then the processing device 52 selects the slower, second clock signal 67 as the display clock 68. Similarly, for a faster frame frequency (“primary frame frequency”) suitable for comfortable viewing, the processing device 52 selects the first clock signal 63.

The LCD controller 54 in this embodiment 50 may be one of numerous commercially available LCD controllers known to those skilled in the art. A typical LCD controller 54 may include a display timing circuit generator 64, an LCD driver 65, and a memory device 61. The LCD controller 54 receives the data and control signals 70, 72 from the processing device 52, stores the digital data 70 to the memory device 61, and generates an analog drive voltage 74 for the LCD 56. The analog drive voltage 74 is generated by the LCD driver 65 using the digital data 70 in the memory device 61 to be displayed on the LCD 56 along with a timing output 75 generated by the display timing circuit generator 64. The timing output 75 from the display timing circuit generator 64 controls the frame frequency of the LCD 56, and is generated as a function of the display clock signal 68 input to the display timing circuit generator 64.

In operation, the frame frequency of the LCD 56 is decreased to the alternate frame frequency by selecting the slower clock signal 67 when a user is not likely to be viewing the LCD 56. For instance, the alternate frame frequency may be selected if the processing device 52 detects a period of inactivity, such as after a pre-determined timeout interval expires without the occurrence of any triggering events. The length of the timeout interval may be based, for example, on desired power savings and user perception. The timeout interval should not, however, be so short that the frame frequency will likely change as the device user is still actively viewing the LCD 56.

When the processing device 52 detects some triggering event, the frame frequency is increased to the primary frame frequency by selecting the faster clock signal 63. For instance, if the system 50 is implemented in a mobile communication device, then the triggering event may, for example, be some activity on a user interface such as a keyboard, keypad, thumb-wheel, or stylus pad. Other types of triggering events may include, for example, the receipt of an electronic message by the mobile communication device, or placing the mobile communication device in an interface cradle.

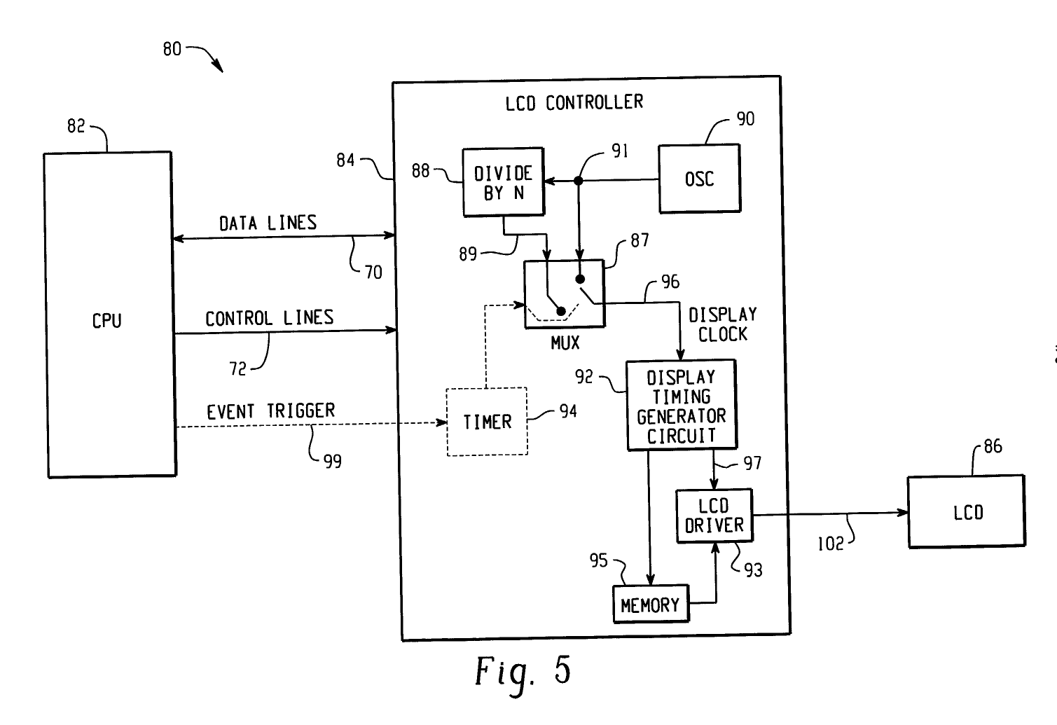

FIG. 5 is a block diagram of another exemplary LCD power conservation system 80. The system 80 includes a processing device 82, an LCD controller 84 and an LCD 86. The LCD controller 84 includes an internal oscillator 90, a divider 88, a switching device 87, a timer 94, a display timing generator 92, an LCD driver 93, and a memory device 95. In this exemplary embodiment 80, the dynamic frame frequency adjustment described above is incorporated into the LCD controller 84.

Operationally, the switching device 87 internal to the LCD controller 84 selects between a first clock signal 91 generated by the internal oscillator 90 and a slower, second clock signal 89 generated by the divider 88. The switching device 87 is controlled by a control input from the timer 94 and couples the selected clock signal 89 or 91 as the display clock input 96 to the display timing generator 92. The display timing generator 92 outputs a timing signal 97 to the LCD driver 93 which controls the frame frequency of the LCD 86 though an analog drive voltage 102.

The display clock signal 96 output from the switching device 87, and thus the frame frequency of the LCD 86, is controlled by the timer 94. The timer 94 monitors an event trigger signal 99 from the processing device 82 which indicates the occurrence of a triggering event. When a triggering event is detected, the timer 94 resets and generates a control signal to the switching device 87, selecting the faster clock signal 91 from the internal oscillator 90 as the display clock 96, and thus selecting the primary frame frequency for the LCD 86. If a pre-determined timeout interval expires before another triggering event is detected by the timer 94, then the timer 94 reduces the frame frequency of the LCD 86 to the alternate frame frequency by selecting the slower clock signal 89 as the display clock signal 96. The event trigger signal 99 may, for example, be a hardware or software signal, or alternatively may be the lack of activity on control lines 72.

In addition, the timer 94 may place the LCD 86 in a reduced pixel mode by generating a reduced-pixel-mode-ON signal to the LCD controller 84 upon expiration of the timeout interval without the occurrence of a triggering event. In reduced pixel mode, portions of the LCD 86 that are not needed when the mobile device user is not actively using the device are automatically turned off or “blanked”. Thus, the user does not have to intervene in order for the device to enter this reduced pixel mode. Then, upon the occurrence of a triggering event, the timer 94 generates a reduced-pixel-mode-OFF signal to the LCD controller 84 to return the LCD 86 to normal operation.

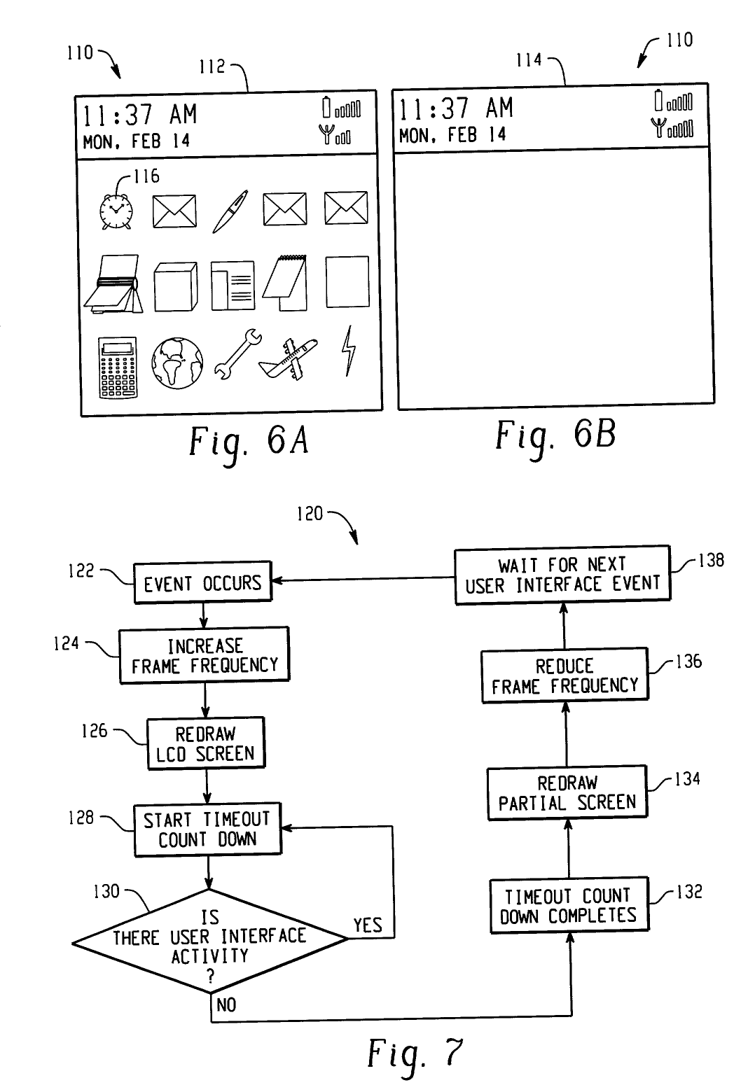

FIG. 6a shows a typical LCD display 110 in a mobile communication device during normal operation 112, wherein a number of application icons 116 are displayed on the LCD. FIG. 6b shows the typical LCD display 110 in an exemplary reduced pixel mode 114, wherein the application icons 116 have been blanked. The difference between the current consumed by a typical LCD during normal operation and a completely blanked LCD screen may generally be around 150 μA. Thus, the use of an automatic reduced pixel mode, either by itself or in combination with the alternate frame frequency, may significantly reduce power consumption by a mobile communication device during periods of inactivity. It should be understood, however, that the reduced pixel mode 114 in FIG. 6b is shown for illustrative purposes only. In other embodiments, placing the LCD in reduced pixel mode may cause different portions of the display to be blanked, or may cause the entire display to be blanked.

In one embodiment, the LCD controller 84 may include a memory device, such as a register set, that stores configurable parameters for the LCD controller 84. The stored parameters may, for example, set the timeout interval of the timer 94, the clock frequency of the internal oscillator 90, the division constant (N) of the divider 88, or other device parameters. An exemplary register set for configuring the LCD controller 84 device parameters may be as follows:

Register 1—defines the number of lines to be blanked in reduced pixel mode;

Register 2—defines the start line for reduced pixel mode;

Register 3—defines the primary frame frequency;

Register 4—defines the alternate frame frequency;

Register 5—defines when to invoke the reduced pixel mode and/or the alternate frame frequency;

Register 6—defines the timeout period; and

Register 7—includes control bits (see Table 1 below). The control bits stored in the register set may, for example, be defined as shown in Table 1.

TABLE 1

| Bit | Power-Up | |
|---|---|---|
| Number | State | Function |
| 0 | 0 | 1 = on timeout invoke reduced pixel mode |
| | | 0 = do not invoke reduced pixel mode on timeout |
| 1 | 0 | 1 = on timeout invoke alternate frame frequency |
| | | 0 = do not invoke alternate frame frequency |
| | | on timeout |
| 2 | 0 | 1 = turn reduced pixel mode on now |
| | | 0 = turn reduced pixel mode on only at timeout |
| 3 | 0 | 1 = invoke alternate frame frequency now |
| | | 0 = invoke alternate frame frequency only at timeout |
| 4 | X | Reserved for future use. |
| 5 | X | Reserved for future use. |
| 6 | X | Reserved for future use. |
| 7 | X | Reserved for future use. |

In one alternative embodiment, the LCD controller 84 may include two timers 94 — one timer to trigger the reduced pixel mode, and one timer to invoke the alternate frame frequency. In this embodiment, the device parameters may be configured to implement each of these two power-saving modes at different times. For instance, the reduced pixel mode may be invoked after a first period of inactivity, such as 10 minutes, and the alternate frame frequency may be implemented after a second period of inactivity, such as 15 minutes.

FIG. 7 is a flow diagram 120 illustrating an exemplary method for implementing dynamic frame frequency adjustment and a reduced pixel mode for an LCD. In step 122, a triggering event is detected. Upon detection of the triggering event, the frame frequency of the LCD is set to its primary frame frequency (step 124) and the reduced pixel mode is turned off (step 126), putting the LCD in its normal mode of operation. Then, a timeout countdown begins at step 128 and is reset at each occurrence of a triggering event (step 130). If the timeout countdown continues without being reset for a pre-determined timeout interval (step 132), then the reduced pixel mode is invoked at step 134 and the frame frequency is set to the alternate frame frequency at step 136. The LCD remains in reduced pixel mode and continues to operate with the alternate frame frequency until a triggering event is detected (step 138), causing the method to repeat at step 122.

This written description uses examples to disclose the invention, including the best mode, and also to enable any person skilled in the art to make and use the invention. The patentable scope of the invention is defined by the claims, and may include other examples that occur to those skilled in the art.

We claim:

1. A system for reducing power consumption by a liquid crystal display (LCD) in a mobile communication device, comprising:
a processing device configured to generate a digital output having a first state and a second state;
an LCD controller coupled to the LCD and having a display clock input, wherein the frequency of the display clock input controls the frame frequency of the LCD; and
a switching device having a first input coupled to a first clock signal and a second input coupled to a second clock signal and having a control input coupled to the digital output of the processing device, wherein the first clock signal has a first frequency and the second clock signal has a second frequency, and wherein the switching device couples the first clock signal to the display clock input to the LCD controller when the digital output of the processing device is in the first state and couples the second clock signal to the display clock input to the LCD controller when the digital output of the processing device is in the second state.

2. The system of claim 1, wherein the switching device is a multiplexer.

3. The system of claim 1, wherein the first frequency is greater than the second frequency.

4. The system of claim 1, further comprising:
an oscillator configured to generate the first clock signal; and
a divider coupled to the oscillator that divides the frequency of the first clock signal to generate the second clock signal.

5. The system of claim 4, wherein the divider is a divide-by-N counter.

6. The system of claim 1, wherein the processing device detects a triggering event in the mobile communication device and generates the digital output in the first state upon detection of the triggering event.

7. The system of claim 6, wherein the triggering event is activity on a user interface.

8. The system of claim 6, wherein the triggering event is the receipt of an electronic message by the mobile communication device.

9. The system of claim 6, wherein the triggering event is connecting the mobile communication device to an interface cradle.

10. The system of claim 1, wherein the processing device detects a period of inactivity in the mobile communication device and generates the digital output in the second state upon detection of the period of inactivity.

11. The system of claim 1, wherein the processing device detects a period of inactivity in the mobile communication device and upon detection of the period of inactivity the processing device generates a reduced-pixel-mode-on signal coupled to the LCD controller, wherein the reduced-pixel-mode-on signal causes a plurality of pixels on the LCD to be turned off.

12. The system of claim 6, wherein the processing device generates the digital output in the second state if a predetermined time interval elapses without the detection of the triggering event.

13. The system of claim 1, wherein the switching device is integral to the LCD controller.

14. The system of claim 4, wherein the oscillator is integral to the LCD controller.

15. The system of claim 4, wherein the divider is integral to the LCD controller.

16. The system of claim 1, wherein the LCD controller includes a display timing circuit generator coupled to the display clock input that controls the frame frequency of the LCD as a function of the display clock input.

17. The system of claim 16, wherein the display timing circuit generator generates a timing output as a function of the display clock input, and wherein the LCD controller includes an LCD driver coupled to the timing output that generates an analog drive voltage coupled to the LCD and that controls the frame frequency of the LCD.

18. The system of claim 1, wherein the processing device includes a data line coupled to the LCD controller, wherein the processing device transmits data over the data line that is displayed on the LCD.

19. The system of claim 18, wherein the processing device includes a control line coupled to the LCD controller, wherein the processing device transmits commands over the control line that control the display of data on the LCD.

20. The system of claim 1, wherein the processing device is a central processing unit (CPU).

21. The system of claim 1, wherein the processing device is a digital signal processor (DSP).

22. A system for reducing power consumption by a liquid crystal display (LCD) in a mobile communication device, comprising:
a processing device configured to detect a triggering event in the mobile communication device and generate an event trigger signal; and
an LCD controller coupled to the processing device, wherein the LCD controller comprises:
a switching device having a control input, a first input coupled to a first clock signal of a first frequency and a second input coupled to a second clock signal of a second frequency; and
a timer coupled to the event trigger signal and the control input of the switching device, wherein the timer generates a control signal on the control input to the switching device to select the first input to the switching device as a display clock output from the switching device when the event trigger signal indicates the occurrence of the triggering event and to select the second input to the switching device as the display clock output from the switching device if the triggering event has not been detected for a pre-determined time interval;
wherein the LCD controller controls the frame frequency of the LCD as a function of the display clock output from the switching device.

23. The system of claim 22, wherein the switching device is a multiplexer.

24. The system of claim 22, wherein the first frequency is greater than the second frequency.

25. The system of claim 22, wherein the LCD controller further comprises:
an internal oscillator configured to generate the first clock signal; and
a divider coupled to the internal oscillator that divides the frequency of the first clock signal to generate the second clock signal.

26. The system of claim 25, wherein the divider is a divide-by-N counter.

27. The system of claim 22, wherein the triggering event is activity on a user interface.

28. The system of claim 22, wherein the triggering event is the receipt of an electronic mail message by the mobile communication device.

29. The system of claim 22, wherein the triggering event is the connection of the mobile communication device to an interface cradle.

30. The system of claim 22, wherein the timer generates a reduced-pixel-mode-on signal to the LCD controller if the triggering event has not been detected for a pre-selected interval of time, wherein the LCD controller turns off a plurality of pixels on the LCD upon detection of the reduced-pixel-mode-on signal.

31. The system of claim 30, wherein the timer generates a reduced-pixel-mode-off signal to the LCD controller when the event trigger signal indicates the occurrence of the triggering event, wherein the LCD controller turns on the plurality of pixels on the LCD upon detection of the reduced-pixel-mode-off signal.

32. The system of claim 22, wherein the LCD controller includes a display timing generator circuit coupled to the display clock output from the switching device that controls the frame frequency of the LCD as a function of the display clock output.

33. The system of claim 22, wherein the display timing circuit generator generates a timing output as a function of the display clock output from the switching device, and wherein the LCD controller includes an LCD driver coupled to the timing output that generates an analog drive voltage coupled to the LCD and that controls the frame frequency of the LCD.

34. The system of claim 22, wherein the processing device includes a data line coupled to the LCD controller, wherein the processing device transmits data over the data line that is displayed on the LCD.

35. The system of claim 34, wherein the processing device includes a control line coupled to the LCD controller, wherein the processing device transmits commands over the control line that control the display of data on the LCD.

36. The system of claim 22, wherein the processing device is a central processing unit (CPU).

37. The system of claim 22, wherein the processing device is a digital signal processor (DSP).

38. The system of claim 22, further comprising:
a second timer coupled to the event trigger, wherein the second timer generates a reduced-pixel-mode-on signal to the LCD controller if the triggering event has not been detected for a pre-selected interval of time, wherein the LCD controller turns off a plurality of pixels on the LCD upon detection of the reduced-pixel-mode-on signal.

39. The system of claim 38, wherein the second timer generates a reduced-pixel-mode-off signal to the LCD controller when the event trigger signal indicates the occurrence of the triggering event, wherein the LCD controller turns on the plurality of pixels on the LCD upon detection of the reduced-pixel-mode-off signal.

40. A method for reducing power consumption by a liquid crystal display (LCD) in a mobile communication device, comprising the steps of:
generating a first clock signal;
dividing the frequency of the first clock signal to generate a second clock signal;
setting the frame frequency of the LCD as a function of the frequency of the first clock signal;
detecting the occurrence of a first triggering event;
monitoring the mobile communication device for the occurrence of a second triggering event;
measuring a time interval beginning with the detection of the first triggering event; and
if the time interval passes without the occurrence of the second triggering event, then setting the frame frequency of the LCD as a function of the frequency of the second clock signal.

41. The method of claim 40, comprising the further step of:
if the second triggering event occurs after the frame frequency of the LCD is set as a function of the frequency of the second clock signal, then resetting the frame frequency of the LCD as a function of the frequency of the first clock signal.

42. The method of claim 40, comprising the further steps of:
measuring a second time interval beginning with the detection of the first triggering event; and
if the second time interval passes without the occurrence of the second triggering event, then turning off a plurality of pixels on the LCD.

43. The method of claim 42, comprising the further step of:
if the second triggering event occurs after the plurality of pixels on the LCD are turned off, then turning the plurality of pixels back on.
